(19) United States
(12) Patent Application Publication
(10) Pub. No.: US 2007/0005960 A1
(43) Pub. Date: Jan. 4, 2007

(54) Wait free coherent multi-level file system

(75) Inventors: Dylan J. McNamee, Portland, OR (US); M. Isaac Jones, Portland, OR (US); Paul T. Graunke, Hillsboro, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Galois Connections Inc.

(21) Appl. No.: 11/172,000

(22) Filed: Jun. 29, 2005

(51) Int. Cl. H04L 9/00

(52) U.S. Cl. 713/166

(57) ABSTRACT

A file system is adapted to employ a hierarchical data structure having a plurality of linked nodes of data pointers identifying data blocks of a file to manage writing of the data blocks without knowledge of, or substantive communication with any file systems with read access. The manner of management enables another file system to coherently read the data blocks of the file, while the file system can continue with write wait free.

### TECHNICAL FIELD

Embodiments of the present invention relate generally to the field of data processing and, in particular, to read down from a higher security level domain to a lower security level domain in a multi domain, multi security levels computing environment.

### BACKGROUND OF THE INVENTION

In certain data processing applications, it may be desirable to have applications from one domain to be able to access data in another domain, but not vice versa. An example of such applications is a multi domain, multi security level computing environment, where it may be desirable for applications in a higher security level domain to access data in a lower security level domain, but not vice versa.

Currently, there are no known file systems that allow a storage device to be simultaneously mounted for read-only access by one file system, and for read-write access by another file system.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an example computing environment suitable for practicing the invention, in accordance with various embodiments;

FIG. 2 illustrates an hierarchical data structure employed by at least a file system of a lower security level domain to manage data blocks of files stored in a mounted storage device, to facilitate wait free coherent read down by another file system of a higher security level domain, in accordance with various embodiments;

FIG. 3 illustrates a node of the hierarchical data structure of FIG. 2 in further detail, in accordance with various embodiments; and

FIG. 4 illustrates the complementary write operational flow of the file system of the lower security level domain in further detail, in accordance with various embodiments.

### DETAILED DESCRIPTION OF ILLUSTRATIVE EMBODIMENTS

Illustrative embodiments of the present invention include but are not limited to a file system adapted to manage read and/or write of data blocks of files stored in storage devices of a domain, in a manner enabling the file system to perform write operations wait free, while another file system of another domain may coherently read the data blocks, without substantive communications between the two file systems for enabling this capability.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising”, “having”, and “including” are synonymous, unless the context dictates otherwise.

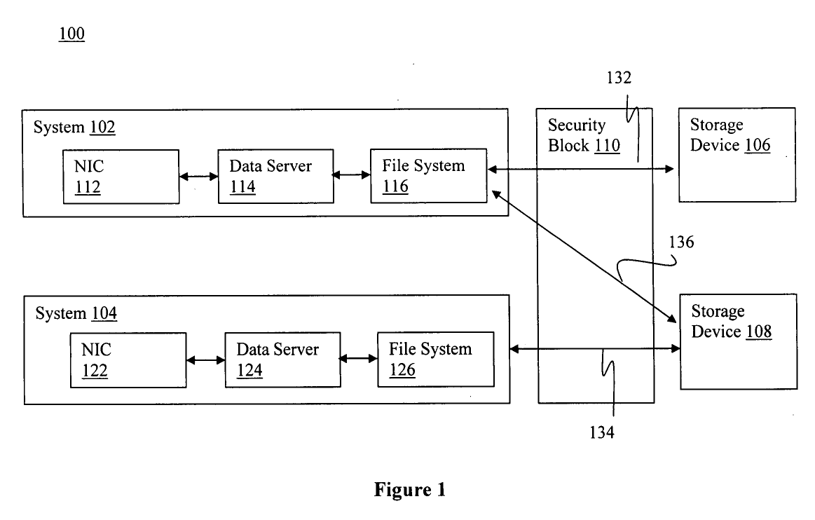

Referring now to FIG. 1, wherein an overview of an example computing environment suitable for practice the invention, in accordance with various embodiments, is shown. As illustrated, for the embodiments, computing environment 100 includes system 102 and storage device 106 being operated in one domain, and system 104 and storage device 108 being operated in another domain. In various embodiments, systems 102 and 104 are coupled to and access storage devices 106 and 108 respectively, through security block 110. For illustrative purpose, the domain of system 102 and storage device 106 is a domain of a higher security level, whereas the domain of system 104 and storage device 108 is a domain of a lower security level. In alternate embodiments, the domains may be differentiated by other attributes beside security levels.

For the embodiments, for ease of understanding, each of systems 102 and 104 is illustrated as having similar components, network interface card (NIC) 112 or 122, Data Server 114 or 124, and File System 116 or 126. However, in alternate embodiments, the systems may have different components.

As will be described in more detail below, at least one of file systems 116 and 126, e.g. file system 126 of the domain with the lower security level, is adapted to manage writing and reading 134 of data blocks of files stored in storage devices 106/108, in a manner that allows file system 126 to perform write operations wait free, while file system of another domain, e.g. file system 116 of the domain with the higher security level may be able to coherently access the data blocks of files stored in storage device 108, without substantive communications between the two file systems, for the purpose of enabling this capability.

In particular, in various embodiments, file system 126 uses an hierarchical data structure having a number of data block pointers identifying the data blocks of the files, and complemented with the operation flow of write operations that make the wait free write by file system 126 and the coherent reads of the data blocks of storage device 118 by file system 116 possible.

In various embodiments, file system 116 of the other domain, e.g. of higher security level, may be similarly constituted as file system 126 of the lower security level domain, for managing reading and writing 132 of data blocks of files in storage device 106. In alternate embodiments, it may not.

While for illustrative purpose, computing environment 100 is illustrated with security block 110, in alternate embodiments, the present invention may be practiced without security block 110. While for ease of understanding, only two domains with two pairs of system and storage device are illustrated, in alternate embodiments, the invention may be practiced with more systems and domains with or without corresponding storage devices.

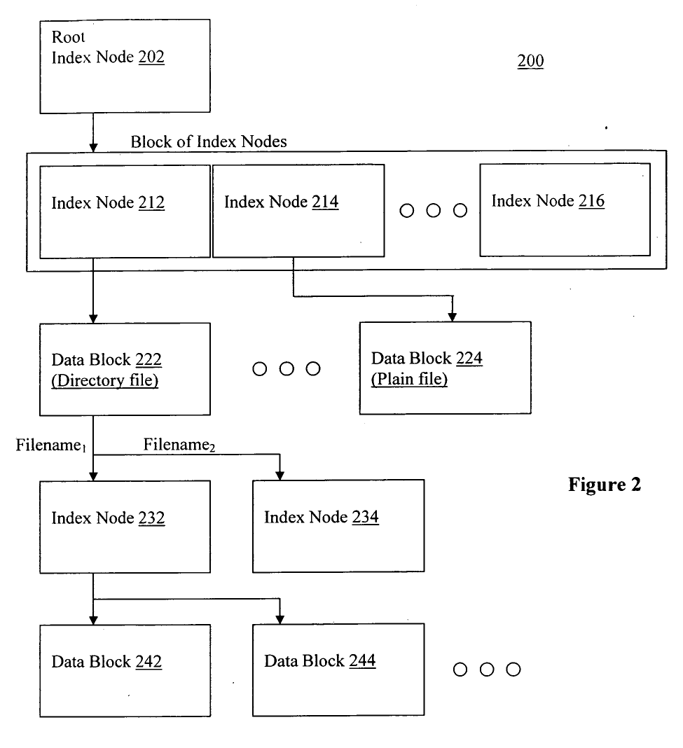

FIG. 2 illustrates the hierarchical data structure for managing reading and writing of data blocks of a file in further details, in accordance with various embodiments of the present invention. As illustrated, for the embodiments, to manage data blocks (such as data blocks 222-224 and 242-244), the data blocks are complemented with hierarchical data structure 200 that includes a root Index Nodes 202 and a number of non-root Index Nodes 212-216, and 232-234. Non-root Index Nodes 212-216 and 232 and 234 are directly or indirectly linked to root Index Nodes 202 or another Index Node (e.g. 212), through one or more data block of pointers (e.g. 222). A data block may be a plain data block, such as data block 224, or a directory data block (also referred to as pointer data block), such as data block 222, which points to other pointer data block or Index Nodes, such as Index Node 232. Index Nodes may also be referred to simply as INodes for short. For the purpose of this specification, the terms are synonymous.

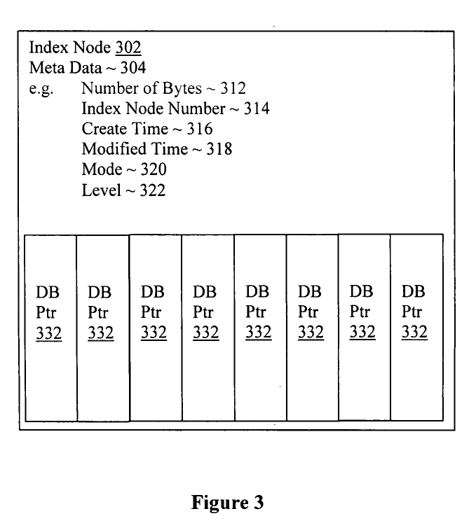

Referring now also to FIG. 3, each Index Node 202, 212-216 and 222-224 includes a plurality of Data Block (DB) Pointers 332 identifying a plurality of member data blocks of a file. While for ease of understanding, only eight DB pointers 332 are illustrated in FIG. 3, in alternate embodiments, an Index Node may have more or less pointers.

Additionally, for the embodiments, an Index Node 302 may further include various meta data about the Index Nodes and/or data blocks identified by the Index Node. Examples of these meta data include but are not limited to

Number of Bytes 312 denoting the size in bytes of the Index Node,

Index Node Number 314 denoting a numeric identifier of the Index Node,

Create Time 316 denoting the time the Index Node was first created,

Modified Time 318 denoting the time the Index Node was last modified,

Mode 320 denoting an INode type, e.g. whether it is a plain file, a directory, etc., and

Level 322 denoting the level of indirection of the Index Node from the predecessor Node.

In various embodiments, an Index Node 302 may have more or less meta data.

In various embodiments, to further improve the efficiency of operation, file system 116 may cache one or more Index Nodes.

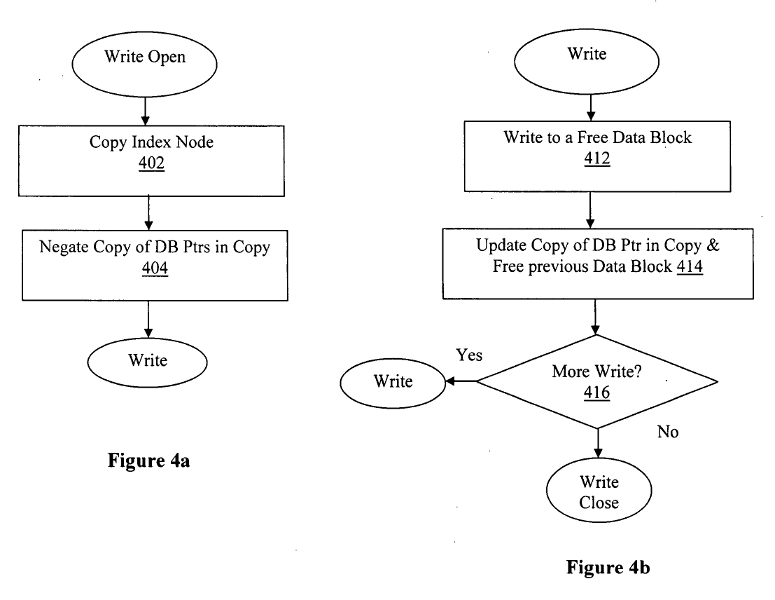

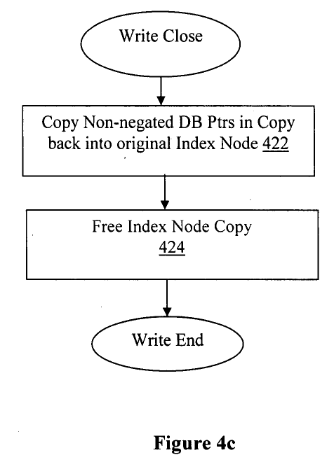

FIGS. 4a-4c illustrate the complementary write operations practiced by file system 126 to enable wait free write by file system 126, while allowing file system 116 to coherently read the data blocks of files in storage device 108 without substantive communication between file systems 126 and 116 to provide the capability.

As illustrated in FIG. 4a, in response to a receipt of a write open request to open a group of data blocks of a file for write data operations, file system 126 makes a copy of the Index Node containing the pointers identifying the data blocks of the file, 402. Additionally, for the embodiments, file system 126 associate the data blocks with respective copy-to-write indications, 404. Specially, for the embodiments, file system 126 transforms the Copy of DB pointer identifying the data block in the Copy of the Index Node, such that the write requester may became aware of the copy-to-write when it retrieves the pointer of the data block. More specifically, for the embodiments, file system 126 negates the Copy of the DB pointer identifying the data block in the Copy of the Index Node. In alternate embodiments, other approaches to conveying the need to perform a copy-to-write may be employed instead.

Referring now to FIG. 4b, as illustrated, on receipt of a write data request, after the write open request, file system 126 writes the data to a free data block 412, and updates the Copy of (transformed) DB Pointer in Copy of Index Node to the newly written data block, and frees the previous data block, 414.

Thereafter, file system 126 waits for further write data request or a write close request, 416. On receipt of another write data request, file system 126 continues operation, starting at operation 412 as earlier described. On receipt of a write close request, file system 126 continues operation as illustrated in FIG. 4c.

Referring now to FIG. 4c, as illustrated, on receipt of a write close request, file system 126 copies the non-transformed DB Pointers back into the original Index Node 422. Further, for the embodiments, file system 126 frees the Index Node Copy, 424.

As will be appreciated by those skill in the art, the employment of the hierarchical data structure with linked Index Nodes, coupled with the complementary write operations advantageously enable a file system of one domain (e.g. file system 126) to write wait free, while a file system from another domain, such as file system 116 (from e.g. a high security level domain) to coherently read data from the domain of file system 126 without having to have any substantive communication between file systems 126 and 116 to provide the capability.

In various embodiments, to facilitate tracking of free data blocks, file system 126 maintains a FIFO queue of pointers to the free data blocks. The FIFO queue has the advantage of delaying reuse of the free data blocks for as long as possible. The FIFO queue is also referred to as a Block Map. In various embodiments, the Block Map is maintained as an Index Node directly linked to the Root Index Node (that is identify by one of the pointers of the Root Index Node).

In various embodiments, similarly, to facilitate tracking of free and used Index Nodes, file system 126 maintains an Index Node Map. In various embodiments, the Index Node Map is maintained as an Index Node directly linked to the Root Index Node (that is identify by one of the pointers of the Root Index Node).

In various embodiments, similarly, to facilitate referencing of the Index Nodes by names, file system 126 maintains Index Node Directory, mapping Index Node names to their numeric identifiers. In various embodiments, the Index Node Directory is maintained as an Index Node directly linked to the Root Index Node (that is identify by one of the pointers of the Root Index Node).

In various embodiments, file system 126 maintains an order of the various write operations. In various embodiments, the order is data blocks, followed by indirect blocks, Index Nodes, and directories.

In various embodiments, security block 110 is employed to inform file systems 116 and 126 of block reuse. This further enhances the likelihood of the correctness of the wait free coherent reads by file system 116, in particular, in situations where storage devices 108 becomes very full, and data blocks are freed and allocated rapidly. Under these situations, it may be possible for file system 116 to read a data block from storage device 108 that does not correspond to the data blocks identified by an Index Node cached by file system 116.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. An apparatus, comprising:
a storage device having a plurality of data blocks;
a file system operatively coupled to the storage device, and adapted to manage writing data into the storage device and reading data from the storage device, including usage of a hierarchical data structure having linked nodes of data block pointers identifying the data blocks of the storage device that are member data blocks of a file, allowing the file system to perform writes into the member data blocks wait free, while another file system can coherent read the member data blocks, the two file systems having no substantive communications with each other to enable the file system to write into the member data blocks wait free while the other file system can coherently read the member data blocks.

2. The apparatus of claim 1, wherein the file system is operated at a first security level, the other file system being operated at a second security level higher than the first security level.

3. The apparatus of claim 1, wherein the hierarchical data structure comprises a root node, and one or more other non-root nodes directly or indirectly linked to the root node.

4. The apparatus of claim 3, wherein the one or more other non-root nodes comprise a first non-root node directly linked to the root node.

5. The apparatus of claim 4, wherein the one or more other nodes further comprise a second non-root node indirectly linked to the root node or the first non-root node.

6. The apparatus of claim 3, wherein each of the root and one or more other non-root nodes comprises one or more meta data, and one or more data block pointers correspondingly identifying one or more data blocks of the file.

7. The apparatus of claim 3, wherein the file system further comprises one or more selected from the group consisting of a map of free data blocks in the storage device, a map of free and used nodes, and a directory correlating node names to node numbers.

8. The apparatus of claim 3, wherein each of the root and one or more other nodes comprises a plurality of data block pointers correspondingly identifying one or more data blocks of the file, and the file system is adapted to handle a write open request to open a first data block of the file for write by making a copy of a first non-root node of the hierarchical data structure containing a first data block pointer identifying the first data block.

9. The apparatus of claim 8, wherein the file system is further adapted to negate the copy of the first data block pointer in the copy of first non-root node.

10. The apparatus of claim 8, wherein the file system is further adapted to handle a write data request to write data into the first data block by writing the data into a second data block, the second data block being a free data block, and updating the copy of the first data block pointer in the copy of the first non-root node to identify the second data block instead of the first data block.

11. The apparatus of claim 10, wherein the file system is further adapted to handle a write close request to close the first data block from write by updating the first data block pointer in the first non-root node with the updated copy of the first data block pointer in the copy of the first non-root node.

12. The apparatus of claim 10, wherein the file system is further adapted to update a map of free data blocks to identify the first data block as a free data block.

13. The apparatus of claim 10, wherein the file system is further adapted to update a map of free and used nodes to identify the copy of the first node as a free node.

14. A computer implemented method, comprising:
receiving a write open request to open a first of a plurality of data blocks of a file for write, the data blocks of the file being managed using a data structure having a plurality of linked nodes of data block pointers identifying the data blocks;
copying a first node having a first data block pointer identifying the first data block;
transforming the copy of the first data block pointer in the copy of the first node;
receiving a write data request to write data into the first data block;
writing the data into a second data block, the second data block being a free data block; and
updated the transformed copy of the first data block pointer to identify the second data block.

15. The method of claim 14, further comprising updating a free data block map to identify the first data block as a free data block.

16. The method of claim 14, further comprising:
receiving a write close request to close the first data block from write; and
updating the first data block pointer in the first node with the updated copy of the first data block pointer in the copy of the first node.

17. The method of claim 16, further comprising updating a free and used node maps to identify the copy of the first node as a free node.

18. The method of claim 14, wherein the transforming comprises negating the copy of the first data block pointer in the copy of the first node.

19. An apparatus comprising:
a storage device;
a file system operatively coupled to the storage device, and adapted to coherently read data blocks of a file from the storage device, the data blocks having been written into the storage device under management by another file system using a hierarchical data structure having a plurality of linked nodes of data block pointers identifying the data blocks of the file, allowing the other file system to write into the data blocks of the file wait free, and the two file systems having no substantive communication with each other to enable the file system to be able to coherently read the data blocks of the file while the other file system can write into the data blocks of the file wait free.

20. The apparatus of claim 19, wherein the file system is operated at a first security level, the other file system being operated at a second security level lower than the first security level.

21. The apparatus of claim 19, wherein the file system is adapted to cache at least one of the linked nodes.

22. A computer implemented method, comprising:
receiving by a first file system a read request to read a data block of a file from a storage device, the data block having been written into the storage device under management of a second file system employing a hierarchical data structure of linked nodes of data block pointers identifying data blocks of the file; and
retrieving coherently by the first file system the data block from the storage device, while the second file system can continue to write into the data block wait free, the two file systems having no substantial communications with each other to enable the first file system to perform the coherent retrieving while the second file system perform the write wait free.

23. The method of claim 22, further comprising operating the first file system at a first security level, the second file system being operated at a second security level lower than the first security level.

24. The method of claim 22, further comprising the first file system caching at least one of the linked nodes.

25. A computing system comprising:
a storage device;
a first file system coupled to the storage device, and adapted to manage writing data blocks of a file into the storage device using a hierarchical data structure of linked nodes of data block pointers identifying the data blocks of the file, the writing being performed wait free; and
a second file system coupled to the storage device, and adapted to manage coherent reading of data blocks of the file, without substantive communication with the first file system to enable the second file system to be able to coherently read the data blocks of the file while the first file system continues to perform the writing wait free.

26. The computing system of claim 25, wherein the first file system is operated at a first security level, and the second file system is operated at a second security level higher than the first security level.

27. The computing system of claim 25, further comprising the second file system caching at least one of the linked nodes.

28. A computer implemented method comprising:
a first file system managing writing data blocks of a file into a storage device, employing a hierarchical data structure of linked nodes of data block pointers identifying the data blocks of the file, the writing being performed wait free; and
a second file system managing coherent reading of the data blocks of the file without substantive communication with the first file system to enable the second file system to be able to coherently read the data blocks of the file, while the first file system continues to write into the data blocks of the file wait free.

29. The method of claim 28, further comprising operating the first file system at a first security level, and operating the second file system at a second security level higher than the first security level.
